(19) United States
(12) Patent Application Publication
(10) Pub. No.: US 2012/0245817 A1
(43) Pub. Date: Sep. 27, 2012

(54) DRIVER ASSISTANCE SYSTEM

(75) Inventors: Troy Otis COOPRIDER, White Lake, MI (US); Shi Shen, Farmington Hills, MI (US); Faroog Ibrahim, Dearborn Heights, MI (US)

(73) Assignee: TK Holdings Inc.

(21) Appl. No.: 13/427,808

(22) Filed: Mar. 22, 2012

Related U.S. Application Data
(60) Provisional application No. 61/466,781, filed on Mar. 23, 2011.

(51) Int. Cl. G06F 19/00

(52) U.S. Cl. 701/70; 701/1

(57) ABSTRACT

A system and method of assisting a driver of a vehicle by providing driver and vehicle feedback control signals is disclosed herein. The system and method includes receiving location data of the vehicle from a GPS unit, retrieving navigation characteristics stored in a map database based on the location data, generating a path tree comprising a set of forward paths the vehicle can take and a path tree root comprising the current path the vehicle is on and generating vehicle data from at least one vehicle sensor. The system and method also includes determining a most probable future path for the vehicle, determining road curvature of the most probable path at a plurality of nodes, comparing the received vehicle data with a threshold at one of the plurality of nodes on the most probable path, and transmitting a control signal in the case that the threshold has been exceeded.

### CROSS-REFERENCE TO RELATED APPLICATIONS

This application claims priority to and the benefit of U.S. Provisional Patent Application No. 61/466,781 filed Mar. 23, 2011. The foregoing provisional application is incorporated by reference herein in its entirety.

### BACKGROUND

Driver assistance systems are becoming more and more prevalent in vehicles. Driver assistance systems can help a driver deal with an upcoming road hazard condition, whether it be an upcoming acute curve in the road or an accident that has occurred in a portion of the road in which the driver is driving towards.

The current method of curve speed warning based on inertial or vision sensors is unreliable as a warning from such methods may be too late because the warning can only be generated once the vehicle is already on the curved portion of a road. Furthermore, the inertial sensor based method is affected by variant driving behavior. In addition, the vision sensor based method depends on the existence, quality and detectability of lane markers which suffers during adverse weather conditions. Furthermore, such systems do not take into account the road bank information. Accordingly, a new design for curve speed warning is that solves these shortcomings is desired.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic diagram of a vehicle control area network;

FIG. 2 is a schematic diagram of various vehicle system components and a general driver assistance system;

FIG. 3 is a schematic diagram of a driver assistance system depicting driver assistance modules related to producing road curvature related determinations;

FIG. 4 depicts a diagram of an improved path of travel determined by a positioning engine;

FIG. 5 depicts a graphical representation of a generated path tree;

FIG. 6 depicts a graphical representation of a most probable path determination;

FIG. 7 depicts a subsection of the most probable path that will be used to determine path curvature calculations; and

FIG. 8 is a general flow chart of a method for producing a curve related control signal.

### SUMMARY OF THE INVENTION

According to an exemplary embodiment, a driver assistance system includes a map database including navigation characteristics, a GPS unit that receives location data of the vehicle, at least one vehicle sensor unit configured to generate vehicle data, a map matching module configured to receive the location data and navigation characteristics and output the location of a vehicle with respect to a road, a path tree module generating a path tree based on the output from the map matching module comprising a set of forward paths the vehicle can take and a path tree root comprising the current path the vehicle is on. The driver assistance system according to one exemplary embodiment also includes a prediction module configured to receive the path tree and determine a most probable future path for the vehicle using a processing circuit wherein the most probable path is segmented into a plurality of nodes having a threshold value, and a warning module configured to compare the threshold value of a node with the vehicle data and transmit a control signal in the case that the threshold value has been exceeded.

According to another exemplary embodiment, a non-transitory computer readable medium storing computer program code that, when executed by a computer, causes the computer to perform a method of assisting a driver of a vehicle includes the steps of receiving location data of the vehicle from a GPS unit, retrieving navigation characteristics stored in a map database based on the location data, generating a path tree comprising a set of forward paths the vehicle can take and a path tree root comprising the current path the vehicle is on, generating vehicle data from at least one vehicle sensor, determining a most probable future path for the vehicle based on the path tree, the vehicle data, and the navigation characteristics, determining road curvature of the most probable path at a plurality of nodes on the most probable path, comparing the received vehicle data with a threshold at one of the plurality of nodes on the most probable path, and transmitting a control signal in the case that the threshold has been exceeded.

According to yet another exemplary embodiment, a driver assistance method includes receiving location data of the vehicle from a GPS unit, retrieving navigation characteristics stored in a map database based on the location data, generating a path tree comprising a set of forward paths the vehicle can take and a path tree root including the current path the vehicle is on and generating vehicle data from at least one vehicle sensor. The system and method also includes determining a most probable future path for the vehicle, determining road curvature of the most probable path at a plurality of nodes, comparing the received vehicle data with a threshold at one of the plurality of nodes on the most probable path, and transmitting a control signal in the case that the threshold has been exceeded.

### DETAILED DESCRIPTION

Before describing in detail the particular improved system and method, it should be observed that the several disclosed embodiments include, but are not limited to a novel structural combination of conventional data and/or signal processing components and communications circuits, and not in the particular detailed configurations thereof. Accordingly, the structure, methods, functions, control and arrangement of conventional components and circuits have, for the most part, been illustrated in the drawings by readily understandable block representations and schematic diagrams, in order not to obscure the disclosure with structural details which will be readily apparent to those skilled in the art, having the benefit of the description herein. Further, the disclosed embodiments are not limited to the particular embodiments depicted in the exemplary diagrams, but should be construed in accordance with the language in the claims.

In general, according to various exemplary embodiments, a driver assistance system includes a digital map system, vehicle sensor input, vision system input, location input, such as global positioning system (GPS) input, and various driver assistance modules used to make vehicle related determinations based on driver assistance system input. The various driver assistance modules may be used to provide indicators or warnings to a vehicle passenger or may be used to send a control signal to a vehicle system component such as a vehicle engine control unit, or a vehicle steering control unit, for example, by communicating a control signal through a vehicle control area network (CAN).

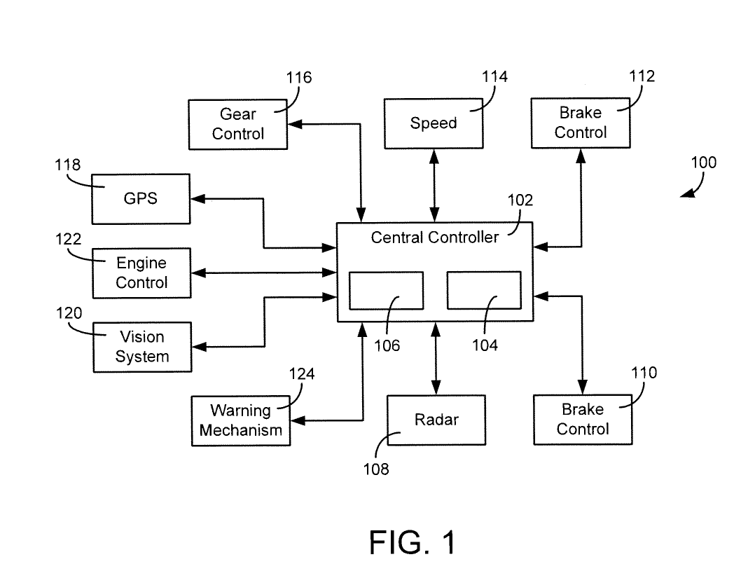

Referring to FIG. 1, a block diagram of a vehicle communication network 100 is shown, according to an exemplary embodiment. Vehicle communication network 100 is located within a vehicle body and allows various vehicle sensors including a radar sensor 108, a speed sensor and/or accelerometer 114, and a vehicle vision system 120 which may include a stereovision camera and/or a monovision camera. In addition, communication network 100 receives vehicle location data from GPS module 118. Furthermore, communication network 100 communicates with various vehicle control modules including brake control modules 110 and 112, gear control module 116, engine control module 122, and warning mechanism module 124, for example. Central controller 102 includes at least one memory 104 and at least one processing unit 106. According to one exemplary embodiment vehicle communication network 100 is a control area network (CAN) communication system and prioritizes communications in the network using a CAN bus.

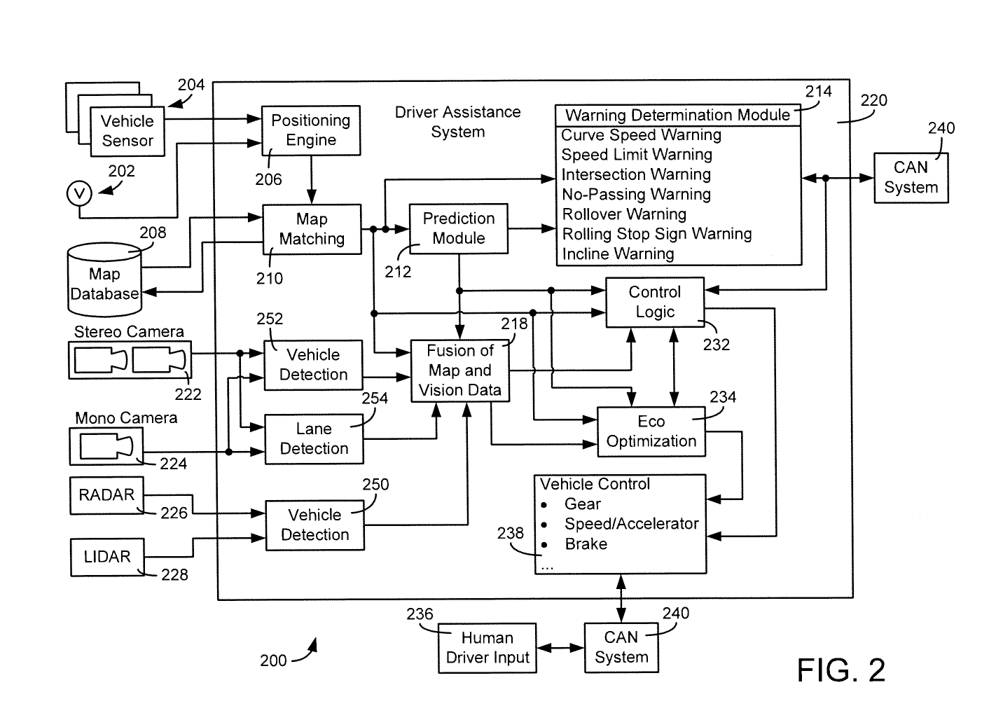

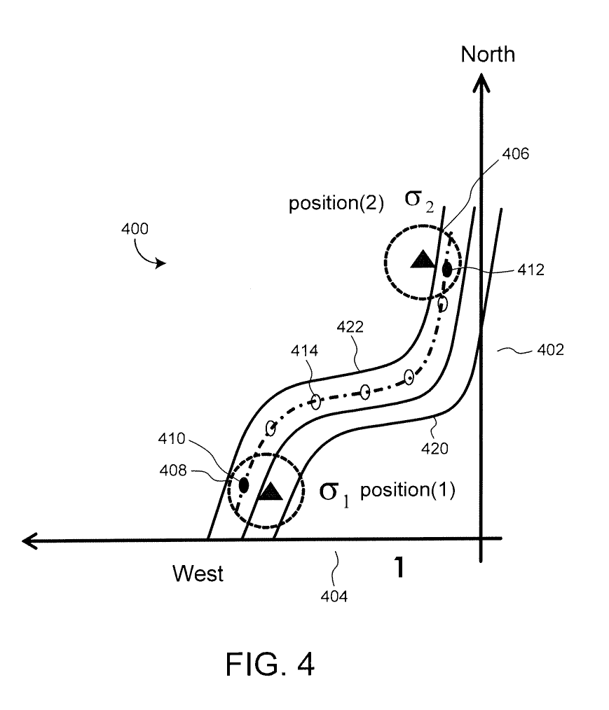

Referring now to FIG. 2, driver assistance system 220 is stored in the memory 104 of central controller 102 according to one embodiment. Driver assistance system 220 includes a map matching module 210. The map matching module 201 includes a map matching algorithm that receives vehicle location data (e.g., latitude, longitude, elevation, etc.) from the GPS unit 202. According to one embodiment, the vehicle location data is enhanced and made more accurate by combining the GPS vehicle location data with vehicle sensor data from at least one vehicle sensor 204 at a positioning engine 206. For example, referring to FIG. 4, GPS data may be able to determine that a vehicle, shown as a triangle in FIG. 4, is located at a series of longitude and latitude coordinates within a circular area 408 on a bidirectional two lane highway signified by lane 420 with traffic moving in a north to south direction and lane 422 with traffic moving in a south to north direction.

According to one exemplary embodiment, vehicle sensor data such as vision data, speed sensor data, and yaw rate data can be combined with GPS data at positioning engine 206 to reduce the set of coordinates that the vehicle may be located to improve the accuracy of the location data. For example, cameras 222 and 224 my be included in vehicle sensors 204 and positioning engine 206 may receive vision data from a camera 222, 224 that has been processed by a lane detection algorithm. According to one embodiment, the lane detection software can modify the received GPS data to indicate that the vehicle is located in lane 422 and not in lane 420 so that the portion of circle 408 not included within lane 422 can be eliminated as a potential vehicle location thereby decreasing the uncertainty of the vehicle location. In addition, other vehicle sensor data such as vision data, speed data, yaw rate data, etc. can be used to further supplement the GPS location data to improve the accuracy of the vehicle location 410.

Driver assistance system 220 also includes or is functionally connected to a map database 208 which includes navigation characteristics associated with pathways and roadways that may be traveled on by a vehicle. According to one embodiment, the map database includes data not included in the GPS location data such as road elevations, road slopes, degrees of curvature of various road segments, the location of intersections, the location of stop signs, the location of traffic lights, no passing zone locations, yield sign locations, speed limits at various road locations, and various other navigation characteristics, for example.

According to one exemplary embodiment, once the positioning engine 206 has determined an enhanced location of the vehicle, the enhanced vehicle location is forwarded to map matching module 210. The map matching algorithm uses the enhanced location of the vehicle from positioning engine 206 or raw location data from the GPS 202 to extract all navigation characteristics associated with the vehicle location. The navigation characteristics extracted from map database 208 may be used for a variety of application algorithms to add to or enhance a vehicle's active or passive electronic safety systems. The application algorithms may be executed alone (i.e., only used with the map data). The application algorithms may also be executed in connection with a variety of vehicle sensors such as RADAR 226, LIDAR 228, monocular vision 224, stereo vision 224, and various other vehicle sensors 204 to add further functionality. One example of various application algorithms is shown in warning determination module 214 which includes application algorithms related to curve speed, speed limit, intersections, no-passing zones, rollover zones, stop signs, and incline zones. Furthermore, control logic module 232 can include further algorithms to determine how various sensor inputs will cause CAN connected vehicle modules to actuate according to a control signal.

According to one exemplary embodiment, the application algorithms may be used to inform the driver directly via human machine interface (HMI) indicators (e.g., audible indicators, visual indicators, tactile indicators) or a combination of HMI indicators. For example, an audible indicator may alert a driver with a audible sound or message in the case that the speed limit warning algorithm determines the vehicle speed is above a speed limit or is about to exceed a speed limit threshold. In a similar manner, visual indicators may use a display such as an LCD screen or LED light to indicate a warning message and tactile indicators may use a vibration element in a vehicle steering wheel, for example, to alert the driver to a warning message output from the warning determination module 214. Furthermore, the application algorithms may also be provided to a vehicle control module 238 to send a control signal to various vehicle actuators 110, 112, 116, and 122 for example, to directly change how the vehicle operates without human intervention.

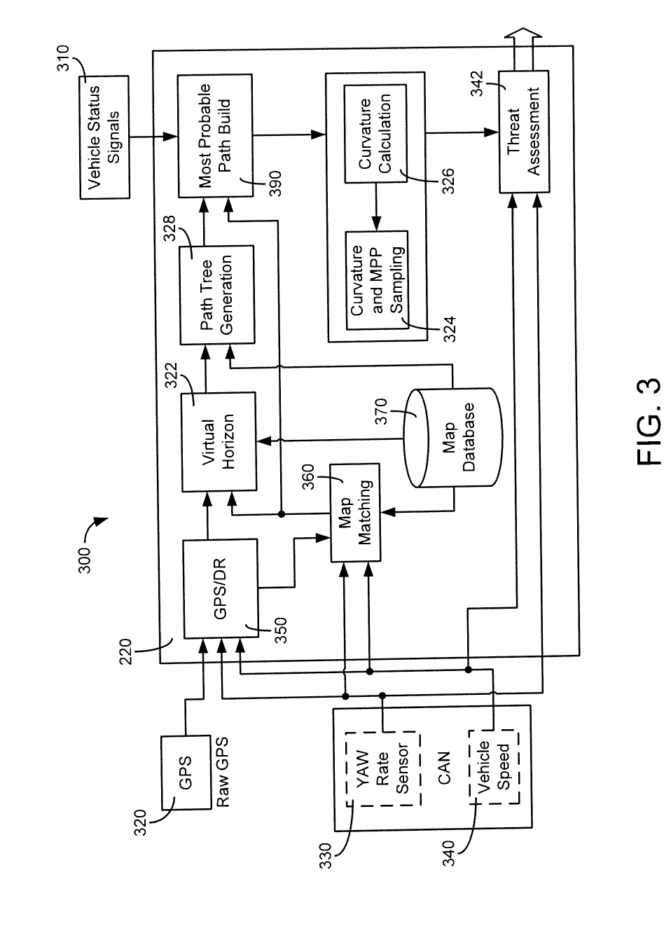

In one embodiment of the present disclosure, the driver assistance system 220 is used to provide a curve speed warning for the driver of the vehicle. According to some embodiments, when the vehicle speed and/or acceleration is over the recommended safe speed for the curvature of the road the vehicle is traveling on, the warning determination module 214 sends a control signal to CAN system 240 to convey a warning indication to driver of the vehicle via an HMI. According to one exemplary embodiment, the curve speed warning is based on the integration of the digital map and stereo vision or monocular vision, with the help of GPS positioning. According to one embodiment as shown in FIG. 3, GPS unit 320 provides the current vehicle location to positioning engine or dead reckoning module 350. Module 350 also receives the vehicle speed from sensor 340, if available, the yaw rate of the vehicle from angular rate sensors 330 (e.g. gyroscope), if available, and acceleration sensors (accelerometers, not shown), if available, at positioning engine 340 in order to calculate position with better accuracy and produce a higher update rate for map matching module 360, virtual horizon module 322, path tree generation module 328, and most probable path building module 390.

As discussed previously with respect to FIG. 4, the resulted fused position map provides a more accurate vehicle location as shown by locations 410 and 412 and further allows the driver assistance system 220 to predict vehicle position points 412 between GPS positions 410 and 412 for more accurate vehicle route data. The GPS and inertial fusion has the benefits of: 1) helping to eliminate GPS multipath and loss of signal in urban canyons, 2) providing significantly better dead reckoning when the GPS signal is temporarily unavailable, especially while maneuvering, 3) providing mutual validation between GPS and inertial sensors, and 4) allows the accurate measurement of instantaneous host vehicle behavior due to high sample rate and relative accuracy of the inertial sensors 330, 340. By way of example, the driver assistance system 400 can handle GPS update rates of 5 Hz or greater.

Referring again to FIG. 3, map matching data produced at map matching module 360 provides an output location of a vehicle with respect to a road and navigation characteristics associated with the road including but not limited to the radius of the road curvature of the current location, and road curvature of an upcoming curve. In addition, the stereo vision or monocular vision system provides the forward looking image of the road environment. Such vision system data may be provided directly to map matching module 360 or may be provided at a later step from sensor module 310, for example. A lane detection and tracking algorithm using the stereo vision or monocular vision system calculates host lane position and lane horizontal curvature. The stereo vision system can also calculate a 3D lane profile including vertical curvature, incline/decline angle, and bank angle information. These calculations may be performed at map matching module 360 or may alternatively be performed at various other modules.

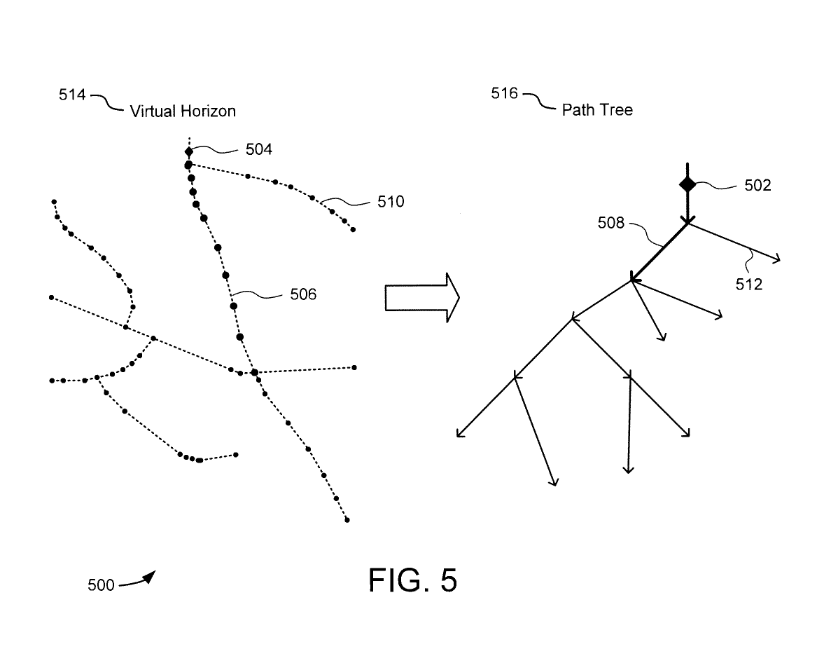

According to one embodiment, prediction module 200 as shown in FIG. 2 comprises virtual horizon module 322, path tree generation module 328, probable path module 390 as shown in more detailed FIG. 3. Accordingly, prediction module 200 receives the output of map matching module 210 to generate a path tree comprising a set of forward paths or roads the vehicle can take such as path 510 and 512 and a path tree root 508 and 506 comprising the current path the vehicle is on as shown in FIG. 5.

Once path tree 516 has been generated, a most probable future path of the vehicle is generated based on the vehicle based on the generated path tree, the vehicle data, and the navigation characteristics. In addition, virtual horizon data 514 is utilized in determining the rest of all possible forward paths the vehicle can take. Path tree 516 as computed by the path tree generation unit 328, downstream algorithms contained in the warning determination module 214, and control logic module 232 can efficiently extract relevant probable paths, or intersecting paths. In some embodiments, the path tree generation unit 328 organizes the links in a hierarchical fashion, providing quick access to link features important in path prediction, such as intersecting angles and travel direction.

Details of output of the map matching unit 360 that are provided to the most probable path building unit 390 according to one or more embodiments is described below. The map matching unit 360 matches the GPS-processed position of the vehicle output by the GPS processing unit 350 (which takes into account the inertial sensor data as provided by the sensors 330, 340) to a position on a map in single path and branching road geometry scenarios. In this way, map matching unit 360 provides navigation characteristics, as obtained from the map database 370 to various locations relevant to a vehicle. According to one example, a GPS position is used as an input to a look up table or software algorithm which is used to retrieve navigation characteristics stored in map database 370.

Furthermore, the map matching unit 360 finds the position on the map that is closest to the corrected GPS position provided by module 350, whereby this filtering to find the closest map position can be performed using an error vector based on the last time epoch. GPS heading angle and history weights can used by the map matching unit 360 in some embodiments to eliminate irrelevant road links. Map matching as performed by the map matching unit 360 can also utilize information regarding the vehicle's intention (e.g., its destination), if available, and also the vehicle trajectory. In some embodiments, map matching can be performed by reducing history weight near branching (e.g., a first road intersection with a second road), and by keeping connectivity alive for a few seconds after branching.

Details of the operation of the most probable path unit 390 according to one or more embodiments is described below. The most probable path unit 390 uses the map-matched position as output by the map matching unit 360 as a reference to look ahead of the host vehicle position, extracts the possible road links, and constructs a MPP (Most Probable Path) from the extracted road links. The MPP construction can be affected by the host vehicle speed. Also, angles between the connected branches making up the MPP are computed and are used with other attributes to determine the ‘n’ MPPs. A path list is then constructed using the ‘n’ MPPs, whereby vehicle status signals as output by the vehicle status signals unit 310 can be used in the selection of the MPPs. Further, a vehicle imaging system can also be utilized in some embodiments to assist in the selection of the MPPs.

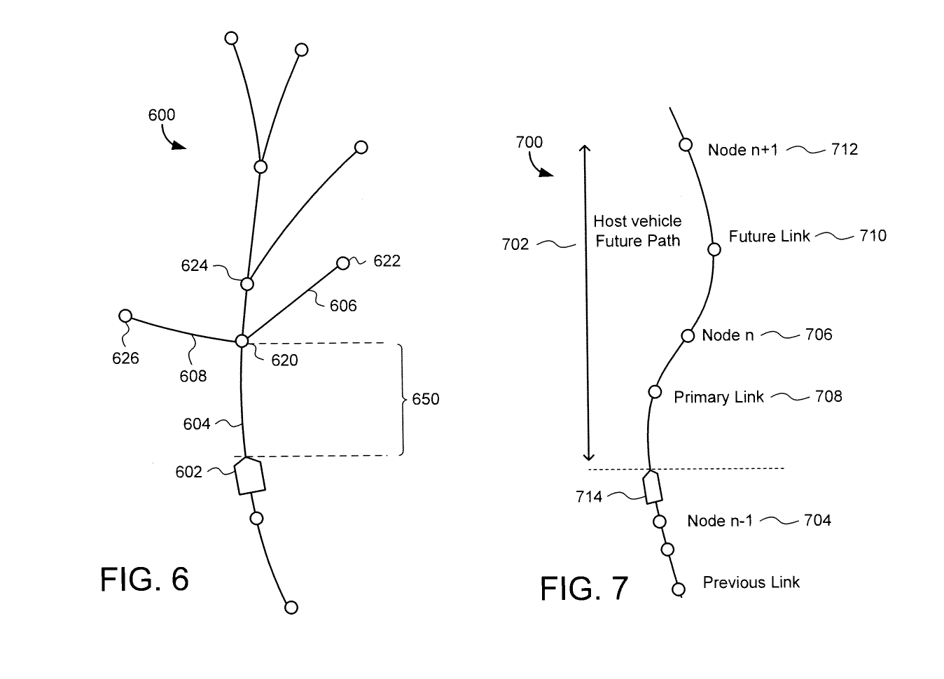

FIG. 6 is a diagrammatic representation of the n MPPs that can be output by the most probable path of a vehicle 602, as shown by way of path tree 600 with the various possible paths shown as branches of the tree 600. For example, the path between nodes 620 and 626 as well as the path between 620 and 622 are both possible future paths while subsection 650 between the vehicle location 602 and node 620 is the path tree root. According to one exemplary embodiment the various nodes on the generated path tree 600 are associated with navigation characteristics retrieved from the map database 370 such as road curve data, intersection data, speed limit data that may be used to determine if a control signal should be transmitted from the warning determination module 214 or the vehicle control module 238.

As shown in FIG. 3, the MPP sampling unit 324 and curvature calculation unit 326 also can be made on one or more of the n MPPs output by the most probable path unit 390. Curvature calculation (CC) can be performed on one or more of the MPPs output by the most probable path unit 390. In some embodiments, curvature is calculated using a second order model and filtered on shape points of an MPP. Also, a higher resolution curvature can be computed for a link, e.g., every several meters, whereby that information can be used in threat assessment as made by the threat assessment unit 342. According to one embodiment, curvature is calculated at each node or path segment as shown in FIG. 6. FIG. 7 shows how curvature calculation can be used to compute a most probable future vehicle path 702 that includes nodes that are connected to each other by links (previous link, primary or current link, and future link). For example, the link previous to node 704 constitutes a previous link.

Referring to FIG. 7, the threat assessment unit 342, which may also be warning determination unit 214 or vehicle control unit 238 as shown in FIG. 2, determines threats on the MPP path 700 of the host vehicle 714. In some embodiments, threat assessment can be performed at each of the nodes 712, 710, 706, and 708 that are distributed along the predicted future path 700. The threat assessment unit 342 evaluates the threat based on the curvature data of the MPP 700 and the inertial sensor data provided by the sensors 330, 340 (see FIG. 4). In some embodiments, the threat assessment unit 342 can calculate the projected lateral acceleration for each node on the MPP 700, whereby for those nodes which exceed a threshold value, the required decelerations are calculated by the threat assessment unit 342 so to bring the projected lateral acceleration under the threshold value. This required deceleration may be provided to a break control module 112 or engine control module 122, for example, to remove the determined threat. In addition, the threat assessment unit 342 can determine a curvature point of interest and a threat associated therewith, whereby each threat may result in the output of a warning to a vehicle operator, wherein the warning is emitted from an HMI, according to one embodiment.

Furthermore, warning determination module 214 may transmit a control signal to an HMI to convey a warning to a vehicle passenger if one of several thresholds is exceeded. Each algorithm included in warning determination module 214 may have one or more thresholds that are monitored. For example, if the current vehicle speed is over the Department of Transportation (DOT) recommended safe speed for the current road curvature and bank angle as determined by a curve speed warning algorithm, or over the posted warning speed of this curve or if a predicted future vehicle speed is over the DOT recommended safe speed for the upcoming lane curvature and bank angle (or over the posted warning speed of this upcoming curve) that the host vehicle is about to enter in a predefined time threshold (e.g., 10 seconds), a control signal may be transmitted from module 214 to a CAN system 240 to be provided to an HMI.

Additionally, the algorithms depicted in warning control module 214 may use various vehicle data collected by vehicle sensors 204 including camera and radar input to calculate the distance and time to an upcoming curve, which, together with the targeted speed, can be provided to the an automatic control module 232 to produce a vehicle control signal at vehicle control module 238 to automatically adjust vehicle speed/deceleration for optimal fuel efficiency without human intervention. Such automatic adjustments may be transmitted as control signals from vehicle control module 238 and provided to a CAN system 240 which distributes the control signal to an appropriate vehicle module such as an engine control module 122 or a brake control module 110, 112.

Based on the road path information as provided by the GPS 202 and the most probable future path as determined by the prediction module 212, the driver assistance system 220 can accurately inform the operator of the vehicle with suitable lead time about an upcoming road condition that may pose a hazard. For example, if the host vehicle 602 enters a curve at a speed that exceeds a defined value, then the vehicle will not be able to negotiate the curve safely. The driver assistance system 220, according to an embodiment of the invention, can warn the driver if the vehicle is moving too fast for the upcoming curve, whereby the driver assistance system can provide warnings through a HMI prior to entering a curve thereby improving on previous curve warning systems and methods.

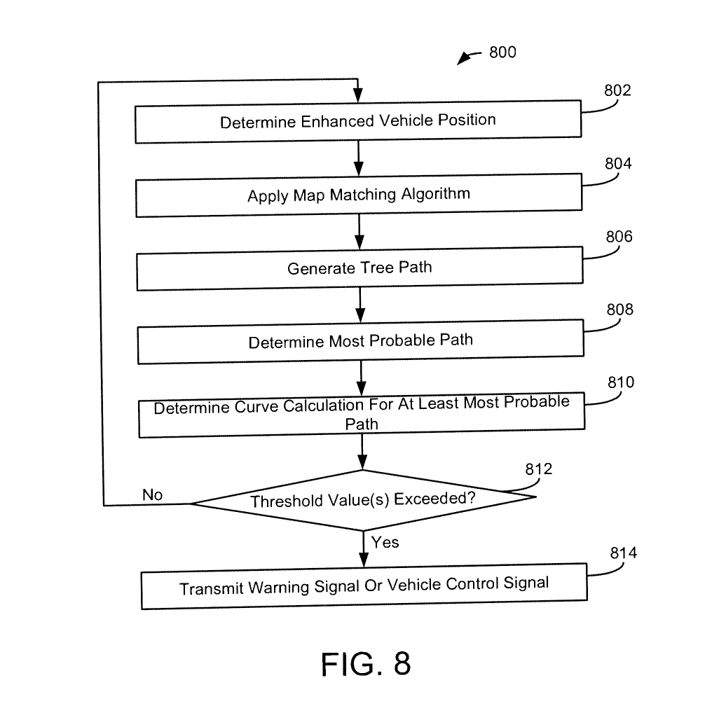

Referring to FIG. 8, a general flow chart of a method for producing a curve related control signal is disclosed. Process 800 may be carried out by several different driver assistance system embodiments 200 or 300 and may be a computer program stored in the memory 104 of central controller 104 and executed by at least one processor 106 in central controller 102. Process 800 is merely exemplary and may include additional steps or may not include one or more steps displayed in FIG. 8. According to one exemplary embodiment, at step 802 driver assistance system 200 determines an enhanced vehicle position. The enhanced vehicle position may be determined at positioning engine 206 or dead reckoning module 350, for example. As stated previously, the positioning engine improves the accuracy of raw GPS data provided by GPS unit 202 using vehicle sensor data 204 including data from camera units 222 and 224 as well as from other sensors such as an accelerometer, a vehicle speed sensor 340, or a YAW rate sensor 330.

Once an enhanced vehicle location is determined at step 802, the vehicle location data, which may comprise a set of coordinates, such as longitude and latitude, is provided to a map matching algorithm stored in map matching module 210 for example at step 804. According to one embodiment, the map matching algorithm uses the vehicle position coordinates as a reference to look up navigation characteristics associated with the position coordinates in map database 208. For example a given coordinate may have an associated elevation above sea level, slope value, road curve measurement, lane data, stop sign presence, no passing zone presence, or speed limit for example. Once step 804 generates a series of relevant location coordinates within a road that are associated with various navigation characteristics, this data is provided to prediction module 212 to generate a path tree 600 at step 806 and a most probable path 700 at step 808. According to one embodiment the most probable path is segmented into a series of nodes, each of which are associated with road curvature data that was retrieved from map database 208. According to another embodiment, prediction module 212 may calculate curvature data for future nodes on the most probable path 710, 712 based on several factors including the shape of the most probable path 700 and the distance between nodes 710, 712 at step 810.

The most probable path and associated navigation characteristics such as road curvature data may then be provided to several other driver assistance modules 218, 232, 234, and 214 for further calculations or processing. According to one embodiment, the most probable path and road curve data is transmitted to warning determination module 214 and entered as input to a curve speed warning algorithm. The curve speed warning algorithm will analyze the most probable path data and compare the vehicles speed or lateral acceleration with a threshold value associated with a most probable path node 706, 708, 710, and 712, for example. According to one exemplary embodiment, the degree of curvature of a link previous to a node, such as the link between node 704 and node 708 will determine a threshold vehicle speed for a particular node 708. For example, the degree of road curvature prior to a node may be inversely related to the magnitude of the speed threshold for that node such that exceptionally curvy links will have a lower speed or lateral acceleration threshold and straight links will have a higher speed threshold.

At step 812, process 800 determines if at least one of one more thresholds for a given node have been exceeded. According to one embodiment, if a threshold value has been exceeded warning determination module 214 provides a control signal to CAN system 240, which in turn actuates an HMI to provide a warning or other indication to a vehicle passenger that a dangerous condition is approaching along the most probable path at step 814. Furthermore, step 814 may take place at control logic module 232, eco optimization module 234, or vehicle control module 238 with additional algorithms providing various threshold determinations. For example, vehicle control module 238 may receive the most probable path data from prediction module 212 and determine based on a gear algorithm or braking algorithm whether to actuate a gear control module 116 or brake module 110, 112 by providing a control signal to CAN system 240.

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the driver monitoring system may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present invention could be accomplished with standard programming techniques with rule based logic and other logic to accomplish the various connection steps, processing steps, comparison steps and decision steps.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

1. A driver assistance system for providing driver and vehicle feedback control signals comprising:
a map database comprising navigation characteristics;
a GPS unit that receives location data of the vehicle;
at least one vehicle sensor unit configured to generate vehicle data;
a map matching module configured to receive the location data, navigation characteristics, and vehicle data to output the location of a vehicle with respect to a road;
a path tree module generating a path tree based on the output from the map matching module comprising a set of forward paths the vehicle can take and a path tree root comprising the current path the vehicle is on;
a prediction module configured to receive the path tree and determine a most probable future path for the vehicle using a processing circuit wherein the most probable path is segmented into a plurality of nodes associated with at least one threshold value;
a warning module configured to compare the threshold value associated with a node with the vehicle data and transmit a control signal in the case that the threshold value has been exceeded.

2. The driver assistance system of claim 1, wherein the control signal is transmitted to a human machine interface configured to convey a warning to a passenger in the vehicle.

3. The driver assistance system of claim 1, wherein the received vehicle data is a measurement of lateral vehicle acceleration and the threshold is an acceleration value.

4. The driver assistance system of claim 1, wherein each of the plurality nodes on the most probable path has an associated road curvature and the threshold acceleration value for each of the plurality of nodes is based on the associated road curvature.

5. The driver assistance system of claim 1, wherein the control signal is transmitted to at least one vehicle module through a vehicle control area network (CAN).

6. The driver assistance system of claim 5, wherein the at least one vehicle module comprises a braking control module and the control signal commands the braking control module to apply a braking mechanism.

7. The driver assistance system of claim 5, wherein the at least one vehicle module comprises a engine control module and the control signal commands the engine control module to alter a process being carried out by the vehicle engine to reduce the acceleration of the vehicle.

8. The driver assistance system of claim 2, wherein the vehicle data comprises yaw rate data received from a yaw rate sensor further wherein the yaw rate data is used to determine a most probable future path for the vehicle.

9. The driver assistance system of claim 1, wherein the most probable future path is selected from amongst the set of possible future paths the vehicle can take and is based on GPS data and at least one of lane tracking data, vision system data, and turn indicator data.

10. The driver assistance system of claim 2, wherein the human machine interface comprises at least one of an audible indicator, a visual indicator, and a tactile indicator.

11. The driver assistance system of claim 1, wherein the control signal is transmitted if any of the at least one threshold are exceeded wherein the at least one threshold comprises a current vehicle speed threshold for a current curve, a predicted future speed threshold for an upcoming curve, and a predicted future speed threshold for an upcoming bank angle.

12. A method of assisting a driver of a vehicle by providing driver and vehicle feedback control signals, the method comprising:
receiving location data of the vehicle from a GPS unit;
retrieving navigation characteristics stored in a map database based on the location data;
generating a path tree comprising a set of forward paths the vehicle can take and a path tree root comprising the current path the vehicle is on;
generating vehicle data from at least one vehicle sensor;
determining a most probable future path for the vehicle based on the path tree, the vehicle data, and the navigation characteristics using a processing circuit;
determining road curvature of the most probable path at a plurality of nodes;
comparing the received vehicle data with at least one threshold value associated with one of the plurality of nodes on the most probable path; and
transmitting a control signal in the case that the threshold has been exceeded.

13. The method of claim 12, wherein the control signal is transmitted to a human machine interface configured to convey a warning to a passenger in the vehicle.

14. The method of claim 12, wherein the received vehicle data is a measurement of lateral vehicle acceleration and the threshold is an acceleration value.

15. The method of claim 14, wherein each of the plurality nodes on the most probable path have an associated road curvature and the threshold acceleration value for each of the plurality of nodes is based on the associated road curvature.

16. The method of claim 12, wherein the control signal is transmitted to at least one vehicle module through a vehicle control area network (CAN).

17. The method of claim 16, wherein the at least one vehicle module comprises a braking control module and the control signal commands the braking control module to apply a braking mechanism.

18. The method of claim 16, wherein the at least one vehicle module comprises a engine control module and the control signal commands the engine control module to alter a process being carried out by the vehicle engine to reduce the acceleration of the vehicle.

19. The method of claim 12, wherein the vehicle data comprises yaw rate data received from a yaw rate sensor further wherein the yaw rate data is used to determine a most probable future path for the vehicle.

20. The method of claim 12, wherein the most probable future path is selected from amongst the set of possible future paths the vehicle can take and is based on GPS data and at least one of lane tracking data, vision system data, and turn indicator data.

21. The method of claim 13, wherein the navigation characteristics associated with the road comprise road curvature and lane data.

22. A non-transitory computer readable medium storing computer program code that, when executed by a computer, causes the computer to perform a method of assisting a driver of a vehicle comprising the functions of:
receiving location data of the vehicle from a GPS unit;
retrieving navigation characteristics stored in a map database based on the location data;
generating a path tree comprising a set of forward paths the vehicle can take and a path tree root comprising the current path the vehicle is on;
generating vehicle data from at least one vehicle sensor;
determining a most probable future path for the vehicle based on the path tree, the vehicle data, and the navigation characteristics;
determining road curvature of the most probable path at a plurality of nodes on the most probable path;
comparing the received vehicle data with at least one threshold associated with one of the plurality of nodes on the most probable path; and
transmitting a control signal in the case that the threshold has been exceeded.

23. The non-transitory computer readable medium according to claim 22, wherein the control signal is transmitted to a human machine interface configured to convey a warning to a passenger in the vehicle.

24. The non-transitory computer readable medium according to claim 22, wherein the received vehicle data is a measurement of lateral vehicle acceleration and the at least one threshold is an acceleration value.

25. The non-transitory computer readable medium according to claim 22, wherein each of the plurality nodes on the most probable path has an associated road curvature and the threshold acceleration value for each of the plurality of nodes is based on the associated road curvature.
